(19) United States
(12) Patent Application Publication
(10) Pub. No.: US 2015/0206212 A1
(43) Pub. Date: Jul. 23, 2015

(54) SYSTEM FOR COLLABORATIVE TRANSACTIONS

(71) Applicant: HIODZ LIMITED, Hong Kong (HK)

(72) Inventor: Ric B. Richardson, Tyagarah (AU)

(21) Appl. No.: 14/504,880

(22) Filed: Oct. 2, 2014

Related U.S. Application Data
(63) Continuation of application No. 13/640,957, filed on Oct. 12, 2012, now abandoned.

(30) Foreign Application Priority Data
Apr. 12, 2010 (AU) 20100001535

(51) Int. Cl. G06Q 30/06

(52) U.S. Cl. CPC G06Q 30/0605

(57) ABSTRACT

An online time-based collaborative contribution system for the purchase of good(s) or service(s) includes a database, a server, a plurality of user devices, and a user interface provided at each user device. The database stores information related to the goods or services, a predetermined amount, and a designated target contribution amount. The server is coupled to the database. The plurality of user devices are connected to the server and the database via a network. The user interface allows a respective user to make a contribution of the predetermined amount towards the designated targeted contribution amount. The server initiates the transfer of the good(s) or service(s) as a function of the contributions made by the user and the designated target contribution amount.

The present invention relates to a system for collaborative transactions and related apparatus and methods. More particularly, the present invention relates to such a system, apparatus and methods particularly but not exclusively suited to transactions online in the form of payments, and where the payments must be completed within a predetermined time period.

### BACKGROUND

Online versions of many transaction types are known in the art. Auction sites where people bid for items on sale are popular. Also there are a growing number of gambling and charity focused online services that duplicate real world activities such as lotteries and raffles. Another less known online service mimics the practice of providing lay-buy or lay-away payment services where the buyer purchases a product online but makes a series of payments towards the purchase before receiving the sold goods.

This service allows a person to purchase a product over a period of time but does not require a credit check or any form of creditworthiness. A credit check and credit worthiness is needed if a person wants to purchase goods, pay them off over time but receive the goods at the beginning of the repayment schedule.

These lay-buy or lay-away services are limited in that only the buyer can make payments towards the product to be purchased. Also this service is only currently being offered by large retailers with a street presence. It is not offered to sellers in online marketplaces such as eBay.

Broadly it can be stated that the problem is to provide a device, a mechanism or a methodology by which entities can participate in a transaction which incorporates at least two parameters which the entity has the ability to trade off one against the other in a fully informed manner. In one preferred form the first parameter is the value of a good or service and the second parameter is the probability of gaining title to the good or service (or at least gaining the benefit of the good or service). In everyday situations a user has no ability to trade off these two parameters—the entity either makes a decision to pay full value and have 100% probability of gaining title (or pay zero value and have zero probability of gaining title). Embodiments of the present invention permit an entity to operate in a range between these two extremes.

Embodiments of the present invention seek to expand on these services by allowing multiple people to contribute to the purchase of almost any product from almost any supplier or seller allowing contributors to help purchase products for others and to allow sellers from online marketplaces to enable lay away type sales arrangements. An alternative embodiment also disclosed allows multiple contributors to enter a lottery or raffle to win, rather than acquire, a particular prize.

Definitions

Transaction

In its broadest form a transaction describes a plurality of contributions made by a plurality of entities resulting in a benefit of the transaction being available to be conferred on at least one of the entities which participated in the transaction. The contributions may be a monetary amount. The contributions may be an “in kind” contribution for example of an item or a service.

Benefit of Transaction.

The benefit of a transaction is the end result of the transaction. Most commonly the benefit will amount to the transfer of title of an item from a seller to a purchaser where, in the present instance, the purchaser is at least one entity from a plurality of collaborative contributors.

U.S. Pat. No. 7,007,228 describes some of the basic components of the Internet and related arrangements. The specification and drawings of U.S. Pat. No. 7,007,228 are incorporated herein by cross-reference. Some of the definitions disclosed in U.S. Pat. No. 7,007,228 are reproduced below with some amendments.

Internet

In its broadest form the Internet is an interconnected network of computers.
The introductory portion of U.S. Pat. No. 7,007,228 describes the Internet as a global network of interconnected computers and computer networks (the “Net”). The Internet connects computers that use a variety of different operating systems including UNIX, DOS, Windows and others. To facilitate and allow the communication among these various systems and languages, the Internet uses a communications protocol referred to as TCP/IP (“Transmission Control Protocol/Internet Protocol”). TCP/IP protocol supports three basic applications on the Internet: transmitting and receiving electronic mail (e-mail), logging into remote computers (the “Telnet”), and transferring files and programs from one computer to another (“FTP” or “File Transfer Protocol”).

### World Wide Web

With the increasing size and complexity of the Internet, tools have been developed to help find information on the network, often called navigators or navigation systems. The World Wide Web (“WWW” or “the Web”) is a navigation system. The Web is an Internet-based navigation system, an information distribution and management system for the Internet, and a dynamic format for communicating on the Web.
The Web seeks to integrate different formats of information, including still images, text, audio and video. A user on the Web using a graphical user interface (“GUI) may transparently communicate with different host computers on the system, access different system applications (including FTP and Telnet), and select different information formats for files and documents including, for example, text, sound and graphics.

### Hypermedia

The Web uses hypertext and hypermedia. Hypertext is a subset of hypermedia and refers to computer-based “documents” in which readers move from one place to another in a document, or to another document. To do this, the Web uses a client-server architecture. The Web servers enable the user to access hypertext and hypermedia information through the Web and the user's computer. (The user's computer is referred to as a client computer of the Web server computers.) The client sends requests to the Web servers, which react, search and respond. The Web allows client application software to request and receive hypermedia documents (including formatted text, audio, video and graphics) with hypertext link capabilities to other hypermedia documents, from a Web file server. The Web, then, can be viewed as a collection of document files residing on Web host computers that are interconnected by hyperlinks using networking protocols, forming a virtual “web” that spans the Internet.

### Uniform Resource Locators

A resource of the Internet is unambiguously identified by a Uniform Resource Locator (URL), which is a pointer to a particular resource at a particular location. A URL specifies the protocol used to access a server (e.g. HTTP, FTP, . . . ), the name of the server, and the location of a file on that server.

### Hyper Text Transfer Protocol

Each Web page that appears on clients of the Web may appear as a complex document that integrates, for example, text, images, sounds and animation. Each such page may also contain hyperlinks to other Web documents so that a user at a client computer using a mouse may click on icons and may activate hyperlink jumps to a new page (which is a graphical representation of another document file) on the same or a different Web server.
A Web server is a software program on a Web host computer that answers requests from Web clients, typically over the Internet. Web servers use a language or protocol to communicate with Web clients which is called Hyper Text Transfer Protocol (“HTTP”). A variety of types of data can be exchanged among Web servers and clients using this protocol, including Hyper Text Mark-up Language (“HTML”), graphics, sound and video. HTML describes the layout, contents and hyperlinks of the documents and pages. Web clients when browsing convert user specified commands into HTTP GET requests, connect to the appropriate Web server to get information, and wait for a response. The response from the server can be the requested document or an error message.

### Browser

After receipt, the Web client formats and presents the data or activates an ancillary application such as a sound player to present the data. To do this, the server or the client determines the various types of data received. The Web Client is also referred to as a Web Browser, since it in fact permits a user to browse documents retrieved from the Web Server.

Notes

The term “comprising” (and grammatical variations thereof) is used in this specification in the inclusive sense of “having” or “including”, and not in the exclusive sense of “consisting only of”.

The above discussion of the prior art in the Background of the invention is not an admission that any information discussed therein is citable prior art or part of the common general knowledge of persons skilled in the art in any country.

### BRIEF DESCRIPTION OF INVENTION

Accordingly, in one broad form of the invention there is provided an online time-based collaborative contribution system for the purchase of goods or services; said system comprising a database in communication with two or more remote users via the Internet; said system permitting said users to make a contribution in a predetermined amount towards a designated target contribution amount.
Preferably the target contribution amount is a monetary value.
Preferably said target contribution amount is the monetary value of a good or service.
Preferably contributions towards a designated target contribution amount must be made within a predetermined target time period.
Preferably if said designated target contribution amount is not made within a predetermined target time the contributions made up to the expiry of the predetermined target time are returned.
In a further broad form of the invention there is provided a dedicated device for permitting time-based collaborative contributions for the purchase of goods or services said dedicated device in communication with a database; the dedicated device adapted to receive input from one or more users; said device permitting said users individually and separately to make a contribution in a predetermined amount towards a designated target contribution amount.
In yet a further broad form of the invention there is provided a ticketing system whereby a predetermined number of tickets are made available for distribution for a specified transaction for a predetermined period of time; and whereby the transaction must be completed by no later than said predetermined period of time; and wherein said predetermined number is publicised; and wherein said predetermined time is publicised; and wherein the transaction result is publicised; and wherein if said tickets are all distributed by said predetermined time or earlier than said predetermined time then one ticket is randomly selected and the entity associated with that ticket is awarded the benefit of the transaction.
In yet a further broad form of the invention there is provided a method of awarding the benefit of a transaction to one entity from a plurality of entities which collaborate on said transaction; said method comprising the steps of:
   publicising the benefit of the transaction; publicising a predetermined period of time by which the transaction must be concluded; publicising a predetermined number comprising the number of contribution portions which will comprise the transaction; distributing said predetermined number of contribution portions to said entities within said predetermined period of time; and wherein if said predetermined number of contribution portions are all distributed by said predetermined time or earlier than said predetermined time then one contribution portion is selected and the entity associated with that contribution portion is awarded the benefit of the transaction.
Preferably said contribution portion is equal in value to all other contribution portions which comprise said transaction.
Preferably the probability of any one contribution portion being selected is equal to that of any other contribution portion being selected.
Preferably a contribution portion is represented by a ticket.
In yet a further broad form of the invention there is provided a device by which entities participate in a transaction and wherein said transaction incorporates at least two parameters; said device providing the entity with the ability to trade off a first parameter against a second parameter in a fully informed manner.
Preferably the first parameter is the value of a good or service.
Preferably the second parameter is the probability of gaining title to the good or service (or at least gaining the benefit of the good or service).

### BRIEF DESCRIPTION OF DRAWINGS

Embodiments of the present invention will now be described with reference to the accompanying drawings wherein:

FIG. 1 is an example of an information screen in accordance with a first preferred embodiment,

FIG. 2 represents graphically an example of a collaborative purchase in accordance with a preferred embodiment,

FIG. 3 is a flowchart of a collaborative lay buy transaction in accordance with an embodiment of the present invention,

FIG. 4 is a flowchart of a collaborative transaction according to a further embodiment,

FIG. 5 is a block diagram of the primary components forming a system for implementing any one of the previously described embodiments,

FIG. 6 is a block diagram of the interconnection of components which can form the system of FIG. 5 and

FIG. 7 is a block diagram of the main components forming a user interaction device usable with any one of the previously described embodiments

FIG. 8 is perspective view of a dedicated hardware device which can implement embodiments of the present invention,

FIG. 9 is a screen shot of the entry screen of a e-commerce website according to a further embodiment of the present invention,

FIG. 10 is a screen shot from the website of FIG. 9 showing one item comprising a benefit of transaction,

FIG. 11 is a further screen shot from the website of FIG. 9 showing parameters associated with a transaction concerning the item of FIG. 10 and

FIG. 12 is a further screen shot from the website of FIG. 9 showing multiple items having a range of transaction values and a range of probabilities of receipt of the benefit of a transaction by a prospective collaborative contributor.

### DETAILED DESCRIPTION OF PREFERRED EMBODIMENTS

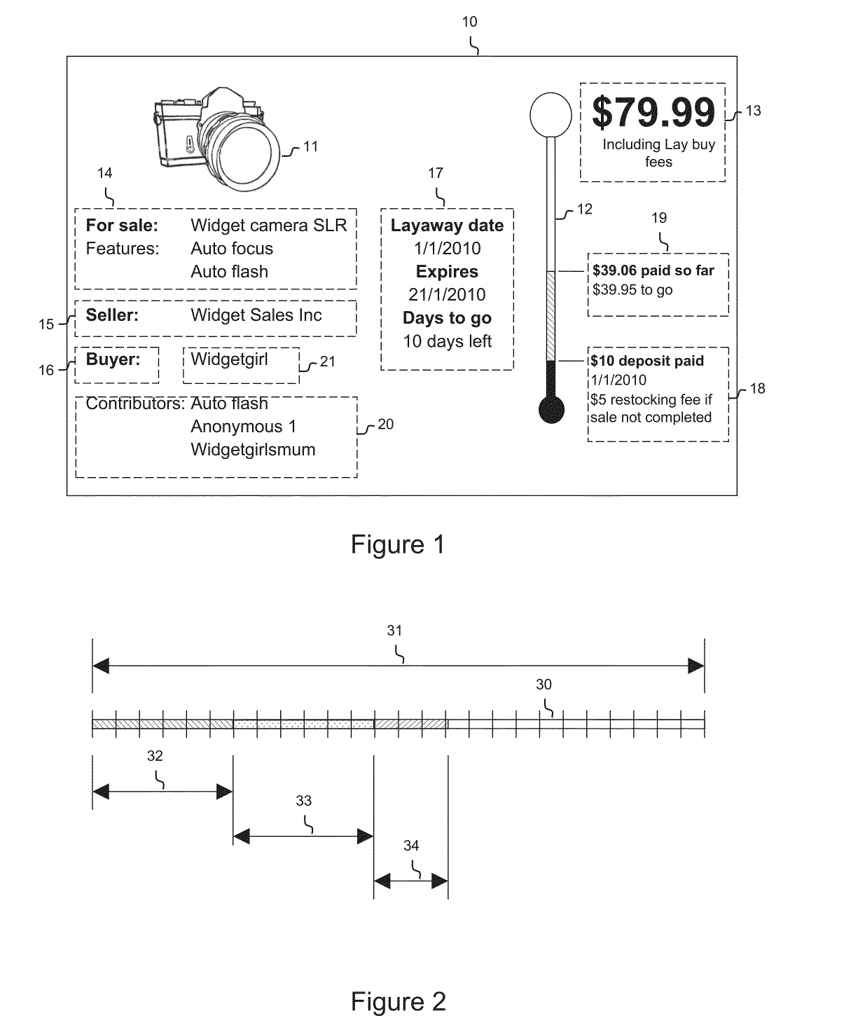

FIG. 1 discloses a simple information screen 10 containing information relating to an online transaction using the invention. In this example case the screen 10 shows a product 11 that has been selected for purchase or acquisition using a lay-buy or lay-away process. The product being purchased 11 is accompanied by product information 14 that informs the buyer of key product features and representations.

The seller 15 of the goods is also listed. This is the person or company with whom the purchaser of the goods makes an agreement to purchase the goods.

In this example the buyer 16 is recognized by the chosen unique account name 21 which represents a person with real world name and purchasing information that has already been collected and vetted prior to being able to make purchases.

Information regarding the law-away arrangements is also displayed 17. Lay-away information could include the date of the initial lay-away deposit, the expiry of the layaway agreement and a listing of the number of days left before the lay-away agreement expires. In this example case the lay-away agreement period is twenty one days. This means that in this case the buyer has twenty one days to purchase the product after which the product could be returned to stock and the money returned to the buyer if the purchase amount has not been paid.

Also on the screen 10 is a graphic scale 12 representing the progress of payments towards the final purchase price 13 of the product. The graphic scale 12 includes a graphic representation with three main components. The deposit paid amount 18 is displayed as a comparable percentage of progress towards the full payment amount 13.

Additionally a progress indicator 19 is displayed on the graphic scale 12 with the explanation that thirty nine dollars and six cents has been paid to date and that there is thirty nine dollars and ninety five cents to be paid before the purchase is completed.

A unique capability of the invention is the ability to allow contributors 20 to make payments towards the purchase price. These contributors can be either related or not related to the purchaser. The example screen shows these contributors 20 by their chosen unique screen names. As in the case of the buyer screen name 21 each contributor 20 will have set up an account that links real world names and payment arrangements to the unique account name displayed.

FIG. 2 displays in more detail the way that a collaborative payment or purchase may be made. The full purchase price 31 represented by the full width of the scale 30 equals the full price to be paid for the product on sale.

Going from left to right on the scale 30 there are a series of part payments 32 33 34 that contribute towards the full purchase price 31 of the product. In this example the first transaction 32 may be equal to the minimum deposit amount needed by the seller for them to be able to offer the lay-away type buying agreement.

The second payment amount 33 may not have been made by the buyer who made the initial payment or deposit 32. In practice each subsequent payment 33 34 could be made

by people who are supportive of the initial buyer. Supportive part payments 33 34 could be made by family, friends or even charitable organizations.

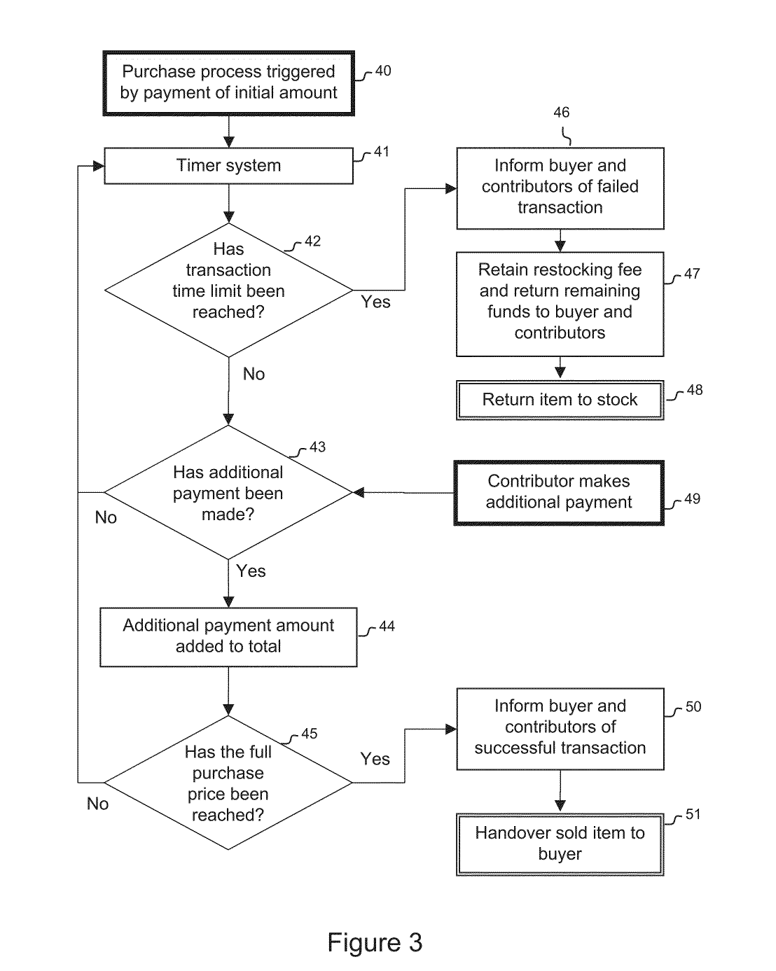

An example process of a collaborative purchase made using a lay-away method can be seen in FIG. 3. In this example embodiment the making of an initial payment 40 triggers the lay-away system. A timer 41 starts counting down the time left in the layaway agreement. At regular intervals the system checks 42 to see if the lay-away agreement time limit terms have expired.

If the agreement term has not expired, then the system checks 43 to see if additional payments have been made towards the purchase of the goods to be sold.

If a contributor has made a payment 49, the total amount paid towards the purchase is recalculated 44 including the most recent contribution. After this the system checks 45 to see if the full purchase price amount has been reached. If not the system sends control back to the timer system 41 and the process is repeated.

If the lay-away agreement period has expired 42 then the system determines that the full purchase price of the item for sale has not been reached. The system then informs the buyer and all contributors of the incomplete purchase 46 and then returns all contributed and part payment funds to the respective payers 47. Additionally a restocking fee may optionally be withheld from the maker of the initial deposit and payment amount 47 and the item held for sale is returned to stock 48 completing the transaction.

If a payment is made 49 and the system determines that the amount for the full purchase price of the item has been reached 45 then the buyer and all contributors are informed of the successful transaction 50 and the item is handed over 51 to complete the sale.

Alternative Embodiments

The example embodiment details an online transaction where multiple users make partial payments in support of an initial payer who wishes to purchase an item online.

With this embodiment any type of item can be sold. These include services, goods, and prizes.

In the example embodiment, the initial contributor is the purchaser. In an alternative embodiment, the initial contributor may not be the recipient of the goods. This may occur where the initial contributor to the purchase nominates another person as the recipient of the goods when the purchase price is met. This may occur in situations such as Wedding Gift registries where the recipient may never make a contribution to the purchase.

In the example embodiment the purchase period time frame is twenty one days. In an alternative embodiment the purchase or winning time frame could be set at any length.

In this model, that is very similar to the earlier embodiment, a time period is predetermined by the seller to allow the buyer to make the purchase with multiple smaller amounts of money over time where the total amount paid is equal to the selling price and the total amount paid. In the event the user does not pay the full amount for the goods being sold on lay buy within the agreed lay away time frame, the item being sold is returned to stock and the money paid by the purchasing user is returned to them.

Another alternative embodiment involves a scenario where no goods, services or other item is involved but simply a predetermined amount of cash is set as the target of the collaborative purchase.

For example the item for purchase is one hundred dollars in cash and users could collaborate to achieve the raising of the cash amount. In this alternative embodiment, the users could contribute towards the total cash prize or amount. The recipient nominated can either be a contributor to the purchase or they may not. This may occur in a situation where friends are putting together cash to help a friend buy something.

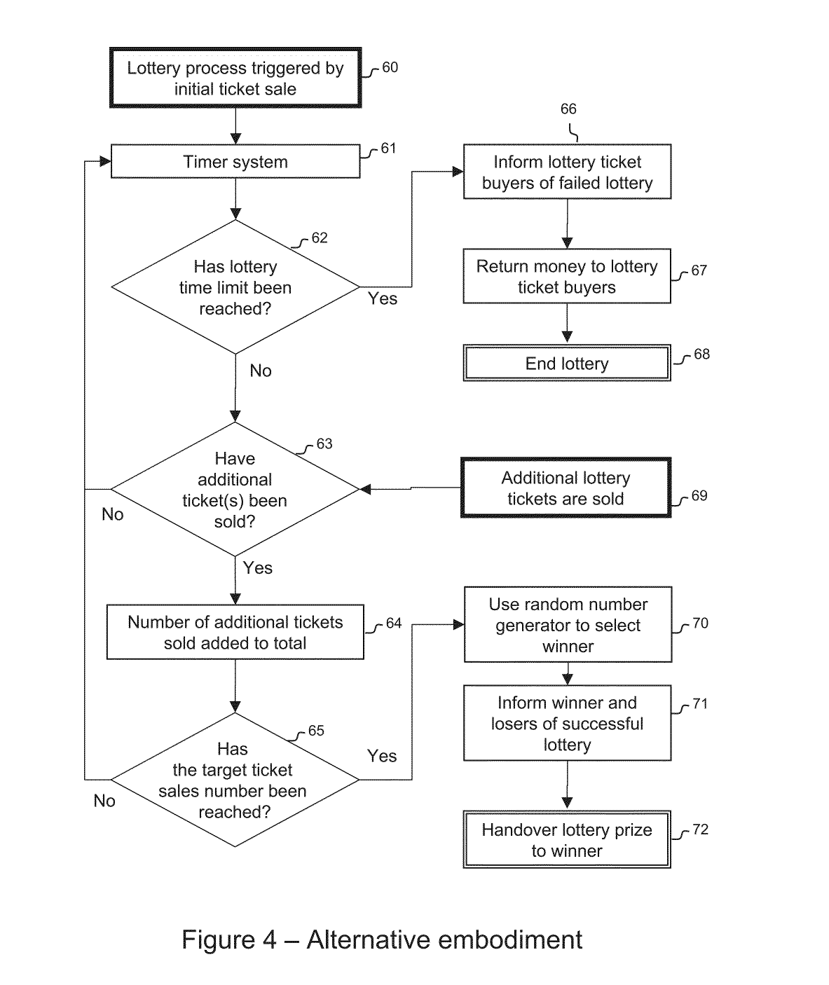

In yet another alternative embodiment described in FIG. 4, the collaborative buying framework of the example embodiment could be adapted for an online lottery or raffle.

Instead of contributing cash amounts, as in the example embodiment, contributors buy tickets representing a specific monetary value that are in turn added to the total of the tickets sold. When the total value of tickets sold reaches the desired sale price or prize value, an electronic raffle is held where a random number generator is used to randomly choose a raffle or lottery ticket from all the tickets sold in the raffle or lottery.

FIG. 4 shows this process. The lottery is triggered by an initial ticket sale 60 towards the price of the prize or item being offered. The timer system 61 is initiated which limits the lottery to specific time frame or period.

The timing system then checks to see if the time limit has been reached 62 before checking to see if any additional tickets have been sold 63. If the timer system determines that the timeframe for the lottery has now expired, then the system informs the lottery ticket buyers that the lottery time frame has expired 66, returns the money to the buyers of the lottery tickets 67 and ends the lottery 68.

If the lottery time frame has not expired then the system checks 63 to see if any additional lottery tickets have been sold 69. If none have been sold then control is passed back to the timer system 61 to re-initiate condition checks.

If additional tickets have been sold, these are added to the total 64 and a calculation made to see if the target number of ticket sales has been reached 65 to initiate the lottery or raffle. If the number is not enough then control is passed back to the timer system 61.

If the number has reached or exceeded the target ticket sales to initiate a lottery draw, a random number generator is used to select one ticket from the tickets that have been purchase 70. The winner is then informed 71 and the lottery or raffle prize is handed over to the winner 72.

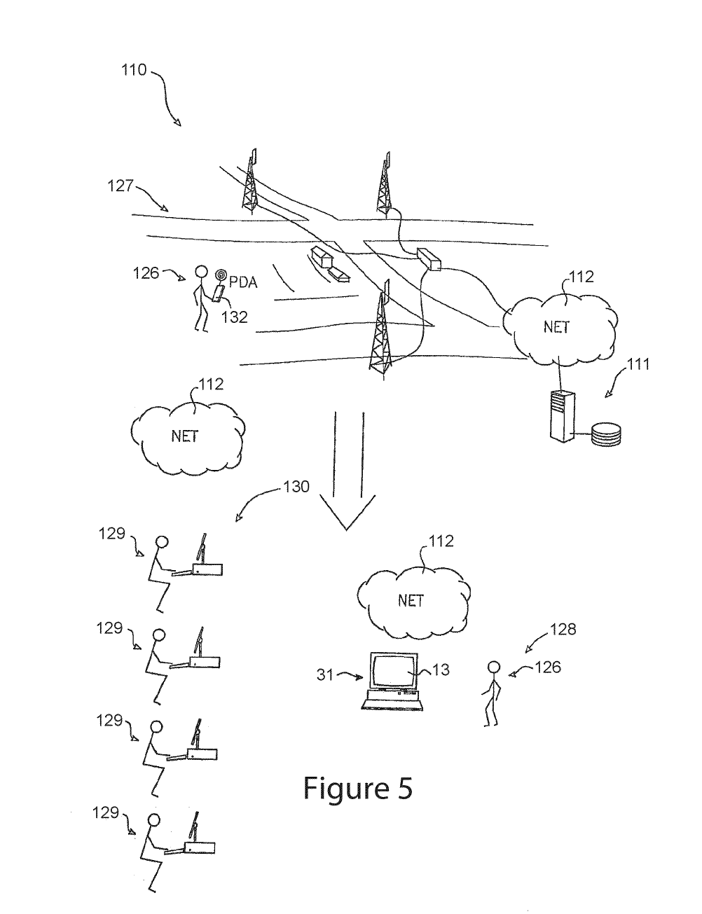

With reference to FIG. 5 there is illustrated a topology of a system in accordance with a further preferred embodiment of the present invention which can be applied to and by which any of the previously described embodiments may be implemented. In this instance, there is illustrated a distributed system 110 comprising a database 111 in communication with the internet 112.

By way of the internet 112, the database is also in communication with at least one input device 113 and at least one output device 114.

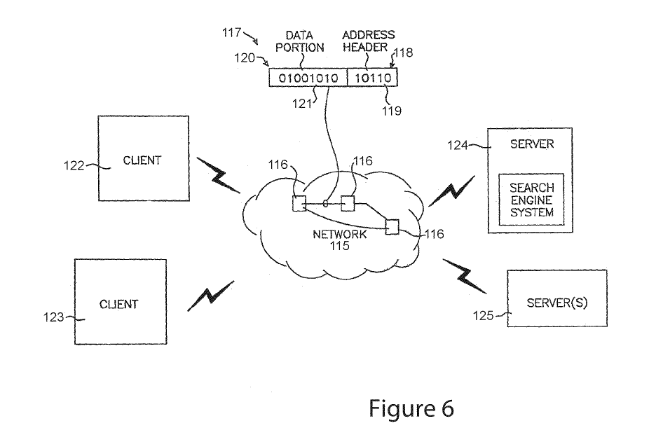

In a particular preferred form, with reference to FIG. 6, the internet 112 forms a part of or the entirety of a network or a digital network 115 comprising an interconnected network of computers 116 and wherein data is transmitted between various ones of the computers 116 forming the digital network 115 by way of packets 117, each packet having a header 118 which contains address data 119 in association with a data portion 120 having digital data 121 therein which, in effect, comprises “pay load” for the data packet 117. The data packets 117 may be transported between the interconnected network of computers according to a defined protocol. In a particular preferred form, the protocol is TCP/IP.

Input device 113 may comprise a client 122 on the network 115. Similarly, the output device 114 may also comprise a client 123 on the network 115.

Similarly, the database 111 may be implemented as part of a server 124 also connected to the digital network 115. There may be other servers 125 associated with the network. These servers may be used for example to serve web pages associated with the database 111 or provide other functionality suited to communicate with users on the network.

The client server arrangement thus far described with reference to FIG. 6 as applied to the system of FIG. 5 can be implemented so as to permit communication between a purchaser 126 armed with a special purpose digital device 132 (in this instance in the form of a personal digital assistant programmed to run a collaborative purchase application) and database 111.

In a particular form, the purchaser 126 can move between an onsite location 127 and a fixed office location 128 remote from the onsite location 127.

The system 110 furthermore permits communication with and input from other people who may generally be designated as collaborative contributors 129. The collaborative contributors 129 may be located at distributed or various other remote locations 130 or may be located with purchaser 126.

In preferred forms, communication with these collaborative contributors 129 may be by digital means.

The purchaser 126 may communicate by other client devices such as personal computer 131 which may comprise either an output device, an input device or, indeed, combine the functions of both for the purposes of communicating with database 111 and with collaborative contributors 129.

### In Use

In use a collaborative transaction is initiated for example when a first collaborator 126—refer FIG. 5—makes a first part payment 32 for a transaction he or she has set up on dedicated user interaction device 132 in communication with database 111. The transaction envisaged may be the purchase of an item such as product 11—refer FIG. 1—or it may be the purchase of a service or it may be the contribution of an item to a pool—refer FIG. 4.

Details of the transaction can be viewed on screen 10 loaded from a web site-served from database 111 by server 124.

Collaborative contributors 129—refer FIG. 5—can also view screen 10 and one or more of them may decide to make a collaborative contribution in this instance in the form of a part payment 33, 34 which will be processed for example according to the flowchart of FIG. 3 by a program located on server 124. Collaborative contributions in this instance in the form of payments 33, 34 can continue to be made by collaborative contributors 129 until in this instance full purchase price 31 is achieved at which time the product 11 is made available and the transaction is otherwise regarded as successfully completed. As indicated in the flow chart of FIG. 3 if a predetermined time elapses without sufficient collaborative contributors 129 contributing sufficient additional part payments 33, 34 then at the end of that predetermined time period the transaction is terminated and the contributions, in this case in the form of part payments, are returned to the respective collaborative contributors 129. The actual predetermined time period will vary according to the circumstances of the transaction. In the case of goods such as a camera it may be appropriate of the transaction to be open for days or weeks. In the case of the lottery ticket transaction of FIG. 4 it may be that the predetermined time period will be of the order of days. There may be instances of transactions where the transaction is open only for minutes or hours. Conversely there may be instances where the transaction remains open for months at a time.

The methodology of embodiments of the present invention may be applied to existing e-commerce sites hosted by servers 124, 135. The methodology of embodiments of the present invention provides an alternative way for a transaction to take place in a collaborative manner within a predetermined time period. The methodology may be accessed by general-purpose personal computers 131 or it may be accessed by a special purpose dedicated user interaction device 132. The dedicated user interaction device 132 may take the form of a personal digital assistant or other portable digital computing device having a program loaded theron (an application or applet) which is programmed according to and facilitates the methodology according to one or more of the various embodiments described above.

Further Embodiment

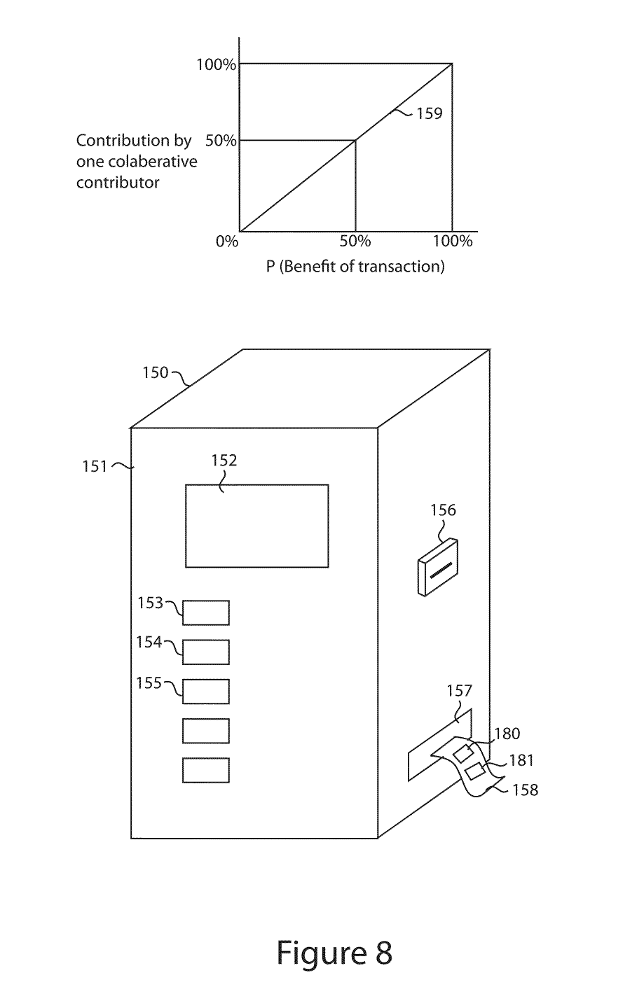

With reference to FIG. 8 there is illustrated a dedicated device 150 comprising an enclosure 151 having a display 152 and activation buttons 153, 154, 155. The device 150 also includes a card reader 156 and a ticket dispenser 157. The graphical arrangement of FIG. 2 can be displayed in display 152 preferably together with an indication of a predetermined time limit by which the transaction must be completed. In use collaborative contributors activate an input button 153 in order to qualify as a collaborative contributor. The benefit of a transaction will be displayed in display 152 together with the time limit by which the transaction must be completed. The contributor may elect to participate in the transaction by purchasing one or more tickets 158 of a predetermined number of tickets available which comprise the transaction and which predetermined number will be displayed in display 152. The collaborative contributor may purchase a ticket by use of the card reader 156 which will accept credit or debit cards. A ticket 158 will then be issued to that collaborative contributor. The ticket will include on it information in the form of indicia which identifies the contribution value 180 and identity information 181 which links the ticket 158 uniquely to the contributor which purchased the ticket.

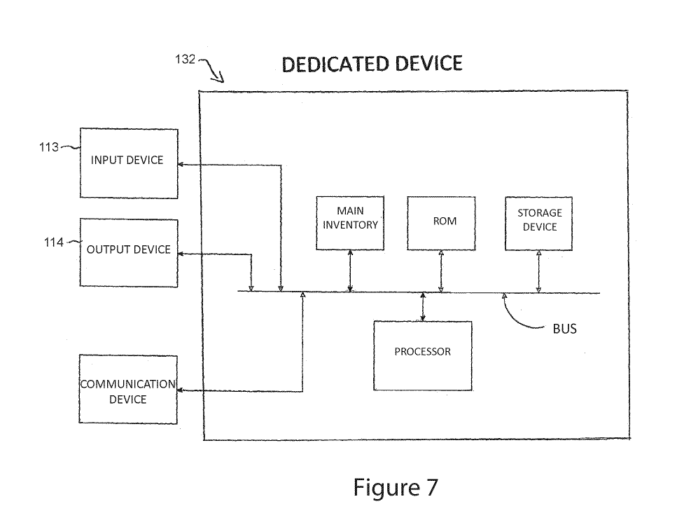

At the end of the predetermined time or before if the predetermined number of tickets 158 have been sold then display 152 will display which ticket has been awarded the benefit of the transaction. That ticket holder may then claim the benefit of the transaction. If the benefit of the transaction is a monetary amount the monetary amount may be deposited into the account associated with the card that was used to purchase the ticket that qualified for the benefit of the transaction. Other forms of benefit may need to be claimed externally to and separate from the dedicated device. In the preferred form the ticket 158 which is selected to qualify for the benefit of the transaction is selected at random from the predetermined number of tickets issued comprising the transaction. The hardware comprising the dedicated device 150 may be as illustrated and previously described with reference to FIG. 7. The dedicated device 150 may communicate over the Internet with a remote server 124 for example in accordance with the topology of FIG. 6.

The graph shown in the inset of FIG. 8 illustrates the control that a contributor has when operating the dedicated device 150 over two parameters of relevance to the contributor. On the horizontal axis a first parameter being the probability of receiving the benefit of a transaction is depicted. The parameter operates between zero and 100% where 100% indicates certainty of receipt of benefit of the transaction. The vertical axis illustrates a second parameter comprising the amount of contribution by one collaborative contributor to the target contribution amount. Again the range lies between zero and 100% where 100% indicates that one collaborative contributor has contributed the entire target contribution amount in which event, as the graph indicates, that collaborative contributor has a 100% probability of obtaining the benefit of the transaction in question. A contributor operating the device 150 may elect to operate anywhere along the characteristic curve 159 which, in this instance, is a straight line on the assumption that all increments available to a prospective collaborative contributor are equal and the probability of obtaining the benefit of transaction is equal to the value of one increment divided by the value of all of the increments making up the target contribution amount. Where each increment is represented by one ticket purchased on the device 150 each ticket has an equal probability to any other ticket of being selected as the ticket which provides the benefit of the transaction.

There may be scenarios where the device is constructed in such a way that other probability profiles are provided.

E-Commerce Embodiment.

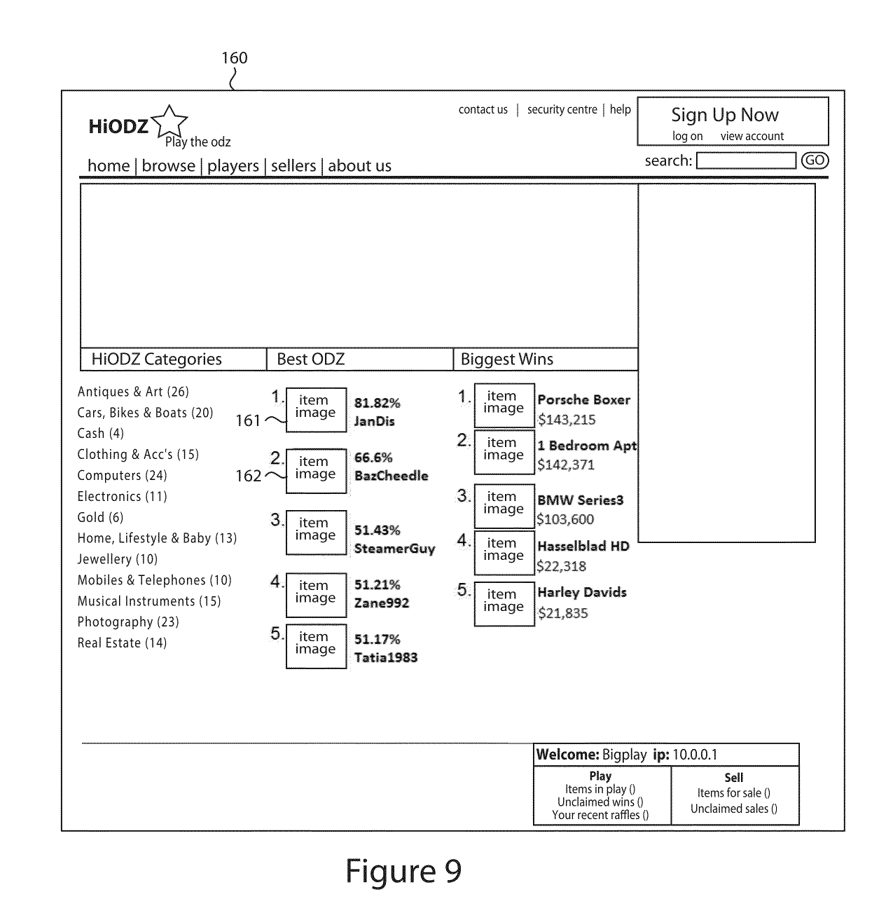

With reference to FIGS. 9, 10, 11 and 12 there are illustrated screen shots of an implementation of an embodiment of the present invention in an e-commerce environment online.

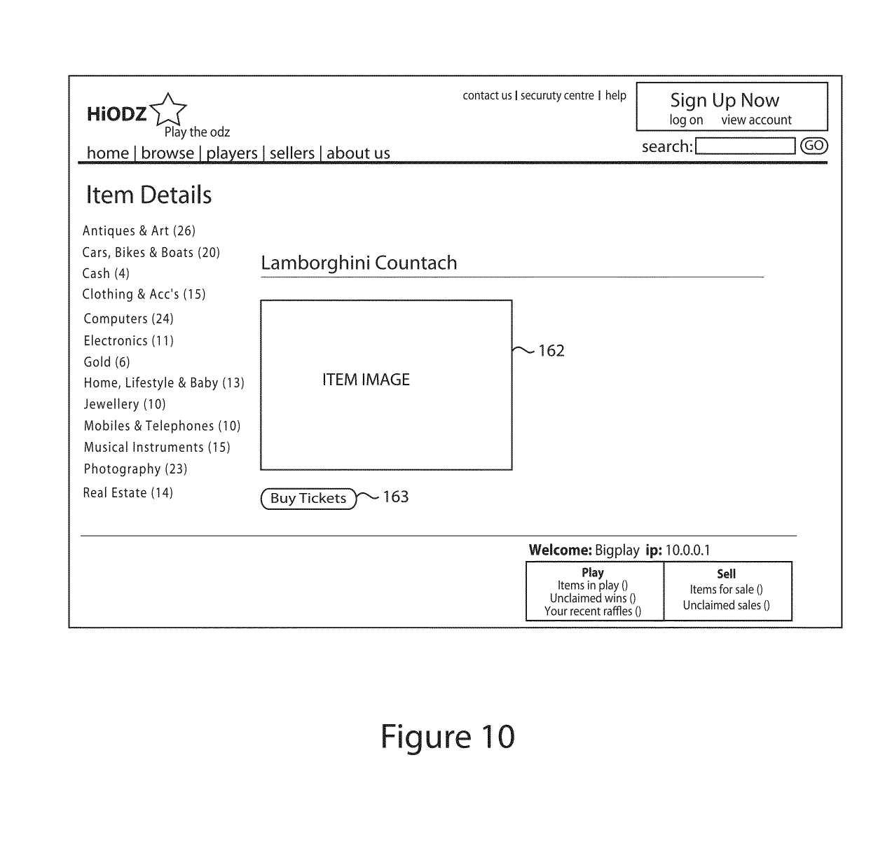

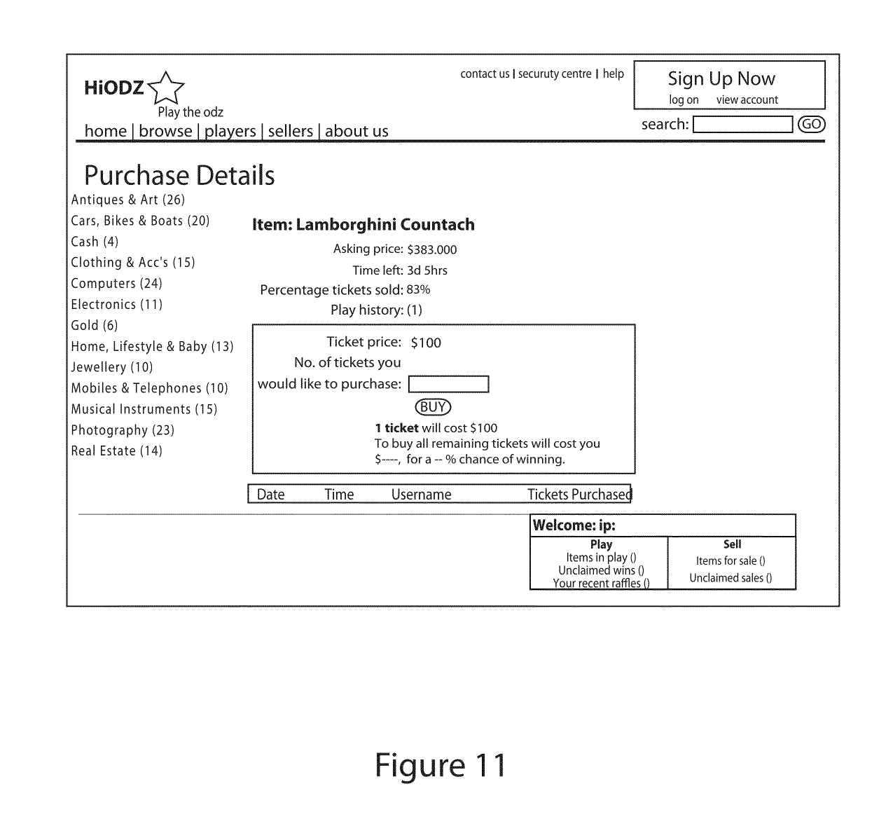

FIG. 9 illustrates an entry screen to an e-commerce Web site 160. The site shows two lots of five items which may be made the subject of transactions and wherein each comprises a benefit of the respective transaction. In this instance there is illustrated a television set 161 and an exotic car 162 amongst various items on offer. If a prospective collaborative contributor clicks through on for example the symbol showing the exotic car 162 they are shown a webpage comprising the screen shot of FIG. 10. If the prospective collaborative contributor elects to participate in the transaction it can click on the buy tickets icon 163 and enter into an e-commerce transaction to buy one or more of the predetermined number of tickets which make up the entirety of the transaction by which the benefit of the transaction mainly the car 162 in this instance will be transferred to at least one of the participating collaborative contributors subject to their ticket keying selected and subject to the transaction proceeding to finalisation within a predetermined time period. In that particular instance of the example shown in FIG. 10 and as shown in the insect on the right-hand side of the screen shot of FIG. 9 the exotic car 162 is the subject of the transaction where there are will be 365 contributions or tickets sold at $100 each making up the transaction amount of $365,000. In the preferred form the probability of any one ticket of the 365 tickets being selected is equal to the probability of any other ticket being selected. That is in a preferred form the selection of the ticket is made in an entirely random way by a digital random number generator. As shown in the screen shot of FIG. 11 details similar to those shown in respect of FIG. 1 of earlier embodiments in this description communicated to the collaborative contributor including the transaction amount (asking price), the predetermined time period for the transaction (time left), the price of an individual collaborative contribution (the ticket price) and, in this instance, progress of the transaction (percentage of tickets sold).

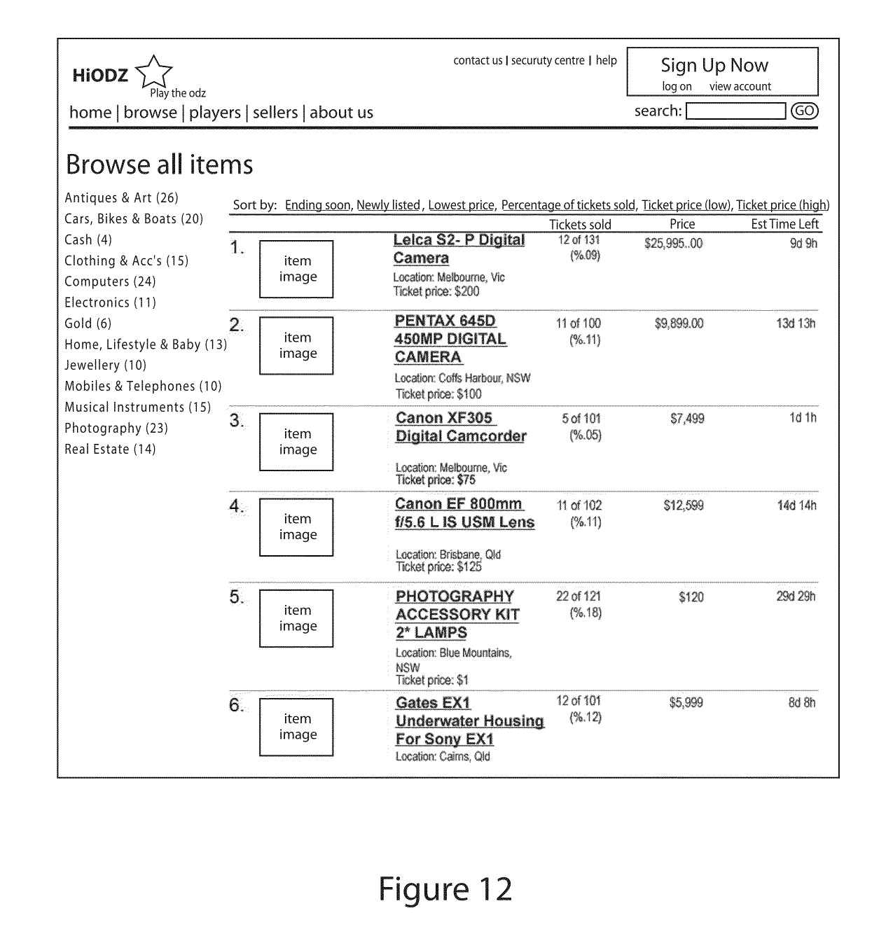

FIG. 12 shows icons for a range of articles which comprise benefits of transactions available on this website. It will be observed that the items can range in value from relatively small amounts (below $1000) to relatively large amounts (tens of thousands of dollars). In all instances a prospective collaborative contributor is informed of the number of contributions (tickets) that make up any one transaction and hence had prospective collaborative contributor can determine the odds of a single contribution (ticket purchase) being the contribution which is awarded the benefit of the transaction (the article displayed). This proceeds on the assumption that there is an equal probability of each contribution (ticket) being drawn. In a preferred embodiment a single entity in the form of a collaborative contributor can purchase more than one ticket thereby to increase the odds that they/it will hold a “winning” qualifying ticket which qualifies the entity to receive the benefit of the transaction namely title to the item the subject of the transaction.

In a preferred form the e-commerce arrangement of FIGS. 9 to 12 can be implemented utilising the topology of FIG. 6.

Whilst in many instances the entity comprising a collaborative contributor will be a person it is possible for a collaborative contributor to be a computer or other machine which participates in the transaction in an automated fashion.

The above describes only some embodiments of the present invention and modifications obvious to those skilled in the art can be made thereto without departing from the scope and spirit of the present invention.

1. An online time-based collaborative contribution system for the purchase of good(s) or service(s), comprising:
a database for storing information related to the goods or services, a predetermined amount, and a designated target contribution amount during a predetermined target period;
a server coupled to the database;
a plurality of user devices connected to the server and the database via a network; and,
a user interface provided at each user device for allowing a each respective user of a plurality of users to make a contribution of the predetermined amount towards the designated targeted contribution amount, the server randomly selecting a user from the plurality of users and initiating transfer of the good(s) or service(s) to the selected user prior to or at the expiration of the predetermined target time period upon the contributions made by the plurality of users being equal to the designated target contribution amount.

2. The system of claim 1 wherein the target contribution amount is a monetary value of a good or service.

3. (canceled)

4. (canceled)

5. The system of claim 4 wherein if said designated target contribution amount is not made within a predetermined target time the contributions made up to the expiry of the predetermined target time are returned.

6. A dedicated device for implementing time-based collaborative contributions for the purchase of goods or services said dedicated device in communication with a database; the dedicated device adapted to receive input from a plurality of users; said device permitting said users individually and separately to make a contribution in a predetermined amount towards a designated target contribution amount associated with a good or service until a predetermined time period expires, wherein the good or service is delivered to a randomly selected one of the plurality of users if the designated target contribution amount is satisfied by the sum of each contribution prior to or at the expiration of the predetermined time period.

7. (canceled)

8. A method of awarding the benefit of a transaction to one entity from a plurality of entities which collaborate on said transaction; said method comprising the steps of: publicising the benefit of the transaction wherein the benefit is associated with a monetary value; publicising a predetermined period of time by which the transaction must be concluded;
publicising a predetermined number comprising the number of contribution portions which will comprise the transaction; distributing said predetermined number of contribution portions at least equal to the monetary value to said entities within said predetermined period of time; and wherein if said predetermined number of contribution portions are all distributed by said predetermined time then one contribution portion is randomly selected and the entity associated with that contribution portion is awarded the benefit of the transaction.

9. The method of claim 8 wherein a said contribution portion is equal in value to all other contribution portions which comprise said transaction.

10. (canceled)

11. The method of any one of claim 8, wherein a contribution portion is represented by a ticket.

12. (canceled)

13. (canceled)

14. (canceled)

15. A method as recited in claim 8, wherein the steps of publicising the benefit of the transaction in which the benefit is associated with a monetary value include; publicising a predetermined number comprising the number of contribution portions which will comprise the transaction; distributing said predetermined number portions at least equal to the monetary value to said entities within said predetermined period of time; and wherein if said predetermined number of contribution portions are all distributed by said predetermined time or earlier than said predetermined time then one contribution portion is randomly selected and the entity associated with that contribution portion is awarded the benefit of the transaction; the method being implemented by a non-transitory computer readable medium.

16. An online time-based collaborative contribution system for the purchase of goods or services provided on non-transitory computer readable medium; said system comprising a database in communication with two or more remote users via the Internet; said system permitting said users to make a contribution in a predetermined amount towards a designated target contribution amount associated with a good or service until a predetermined time period expires, wherein the good or service is delivered to a randomly selected one of the remote users if the designated target contribution amount is satisfied by the sum of each contribution prior to or at the expiration of the predetermined time period.

17. The system of claim 16 wherein the target contribution amount is a monetary value of a good or service.

18. The system of claim 16 wherein contributions towards a designated target contribution amount must be made within a predetermined target time period.

19. The system of claim 18 wherein if said designated target contribution amount is not made within a predetermined target time the contributions made up to the expiry of the predetermined target time are returned.

20. A ticketing system whereby a predetermined number of tickets are made available for distribution for a specified transaction for a predetermined period of time; and whereby the transaction must be completed by no later than said predetermined period of time; and wherein said predetermined number is publicised via a display device; and wherein said predetermined time is publicised via a display device; and wherein the transaction result is publicised via a display device; and wherein if said tickets are all distributed by said predetermined time or earlier than said predetermined time then one of said tickets is randomly selected by a selection device and the entity associated with that ticket is awarded the benefit of the transaction.

21. A method of awarding the benefit of a transaction to one entity from a plurality of entities which collaborate on said transaction; said method comprising the steps of:
publicising the benefit of the transaction via a display device; publicising a predetermined period of time by which the transaction must be concluded via a display device; publicising a predetermined number comprising the number of contribution portions which will comprise the transaction via a display device; distributing said predetermined number of contribution portions to said entities within said predetermined period of time; and wherein if said predetermined number of contribution portions are all distributed by said predetermined time or earlier than said predetermined time then one contribution portion is randomly selected from the predetermined number of contribution portions and the entity associated with that contribution portion is awarded the benefit of the transaction.

22. The method of claim 21 wherein a said contribution portion is equal in value to all other contribution portions which comprise said transaction.

23. The method of claim 21 wherein the probability of any one contribution portion being selected is equal to that of any other contribution portion being selected.

24. The method of claim 21 wherein a contribution portion is represented by a ticket.

25. The method of claim 21, wherein the steps of publicising the benefit of the transaction via a display device further include; publicising a predetermined period of time by which the transaction must be concluded via a display device; publicising a predetermined number comprising the number of contribution portions which will comprise the transaction via a display device; distributing said predetermined number of contribution portions to said entities within said predetermined period of time; and wherein if said predetermined number of contribution portions are all distributed by said predetermined time or earlier than said predetermined time then one contribution portion is randomly selected from the predetermined number of contribution portions and the entity associated with that contribution portion is awarded the benefit of the transaction are implemented by a non-transitory computer readable medium.

26. A method as recited in claim 21, further comprising the step of displaying the predetermined period of time by which the transaction must be concluded.
